(19) United States
(12) Patent Application Publication
(10) Pub. No.: US 2019/0184787 A1
(43) Pub. Date: Jun. 20, 2019

(54) PANEL AND DEFROST PLENUM

(71) Applicant: Ford Global Technologies, LLC, Dearborn, MI (US)

(72) Inventors: James Robert Hurd, III, Northville, MI (US); Michael Murphy McElroy, South Lyon, MI (US); Steve Michael Kahrs, Canton, MI (US); Jennifer A. Herr-Rathke, Plymouth, MI (US); Jose A. Nava, Plymouth, MI (US)

(21) Appl. No.: 15/848,194

(22) Filed: Dec. 20, 2017

(51) Int. Cl. B60H 1/00; B60S 1/02; B60S 1/54; B60K 37/00

(52) U.S. Cl. CPC B60H 1/00564; B60H 1/00271; B60H 1/00842; B60K 2350/401; B60S 1/54; B60K 37/00; B60H 2001/00721; B60S 1/023

(57) ABSTRACT

A panel and defrost plenum includes a manifold section, an air feed section and a branch section. The manifold section includes a first air distribution door, a second air distribution door and an optional third air distribution door. The manifold section also includes at least one actuator to displace the first air distribution door, the second air distribution door and the optional third air distribution door if present, between multiple operating positions. The air feed section is located upstream of the manifold section and functions to deliver an airstream past a package restriction to the manifold section. The branch section is downstream from the manifold section. A related method of routing an airstream past a package restriction is also disclosed.

### TECHNICAL FIELD

This document relates generally to the motor vehicle equipment field and, more particularly, to a new and improved panel and defrost plenum, also known as a panel and defrost duct assembly, that is space efficient and allows delivery of an airstream past a package restriction such as a heads-up display (HUD).

### BACKGROUND

A heads-up display (HUD) is a transparent display that projects data or other information onto the windshield of a motor vehicle where it is visible without requiring the driver/operator of the motor vehicle to look away from the forward view utilized to drive the motor vehicle. The automotive industry is currently adopting new generation HUD technology which enhances the user/driver experience.

These new generation HUD units occupy a relatively large space inside the instrument panel of the motor vehicle thereby limiting space available for heating, ventilating and air conditioning (HVAC) system components providing occupant climate comfort. This document relates to a new and improved panel and defrost plenum that is more space efficient and is particularly suited for delivering an airstream past a HUD package restriction while still providing the desired heating and cooling performance at lower noise levels.

### SUMMARY

In accordance with the purposes and benefits described herein, a new and improved panel and defrost plenum is provided. That panel and defrost plenum comprises a manifold section including a first air distribution door, a second air distribution door and at least one actuator to displace said first air distribution door and said second air distribution door between multiple operative positions. In addition, the panel and defrost plenum further comprises an air feed section upstream of the manifold section. The air feed section delivers an airstream past a package restriction to the manifold section. In addition, the panel and defrost plenum further comprises a branch section downstream from the manifold section.

The manifold section may include a first air discharge port, a second air discharge port and a third air discharge port. The branch section may include a first branch duct extending from the first air discharge port to an outboard panel duct outlet. The branch section may include a second branch duct extending from the second air discharge port to a windshield defrost duct outlet. The branch section may include a third branch duct extending from the third air discharge port to a side window demist duct outlet. The first air distribution door may be configured to control the flow of the airstream through the first air discharge port to the outboard panel duct outlet. The second air distribution door may be configured to control the flow of the airstream through the second air discharge port to the windshield defrost duct outlet and the third air discharge port to the side window demist duct outlet.

The at least one actuator may include a first actuator configured to displace the first air distribution door and a second actuator configured to displace the second air distribution door.

In at least one of the many possible embodiments of the panel and defrost plenum, the manifold section may include a third air distribution door. In such an embodiment, the second air distribution door is configured to control the flow of the airstream through the second air discharge port to the windshield defrost duct outlet. The third air distribution door is configured to control the flow of the airstream through the third air discharge port to the side window demist duct outlet.

In accordance with an additional aspect, a method is provided of routing an airstream past a package restriction such as, for example, an HUD. That method comprises the steps of delivering the airstream in a feed section of a plenum past the package restriction to a manifold section of the plenum and displacing a plurality of air distribution doors in the manifold section to direct the airstream through a branch section of the plenum, downstream of the manifold section, to a plurality of outlets.

The method may include the step of providing the manifold section with a plurality of air discharge ports connected to the branch section. Further, the method may include the step of connecting a first air discharge port with an outboard panel duct outlet. In addition, the method may include the step of connecting a second air discharge port with a windshield defrost duct outlet. Further, the method may include the step of connecting a third air discharge port with a side window demist duct outlet.

Still further, the method may include the step of providing a first air distribution door to control flow of the airstream through the first air discharge port and a second air distribution door to control flow of the airstream through the second air discharge port and the third air discharge port. In addition, the method may include the step of controlling displacement of the first air distribution door and the second air distribution door with a single actuator.

In an alternative method embodiment, the method may include the step of providing a first air distribution door to control the flow of the airstream through the first air discharge port, a second air distribution door to control the flow of the airstream through the second air discharge port and a third air distribution door to control flow of the airstream through the third air discharge port. Still further, the method may include the step of controlling displacement of the first air distribution door, the second air distribution door and the third air distribution door with a single actuator.

In the following description, there are shown and described several preferred embodiments of the panel and defrost plenum and the related method of routing an airstream past a package restriction. As it should be realized, the panel and defrost plenum and related method are capable of other, different embodiments and their several details are capable of modification in various, obvious aspects all without departing from the panel and defrost plenum and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the panel and defrost plenum and related method and together with the description serve to explain certain principles thereof.

FIG. 1 is perspective view of the panel and defrost plenum and a schematic view of the HVAC system and air circulation fan of the HVAC system which delivers conditioned air from the HVAC system to the panel and defrost plenum.

FIG. 2 is a schematic block diagram further illustrating the panel and defrost plenum also shown in FIG. 1.

FIG. 3a-3d are schematic block diagrams of the control systems for four different embodiments of the new and improved panel and defrost plenum.

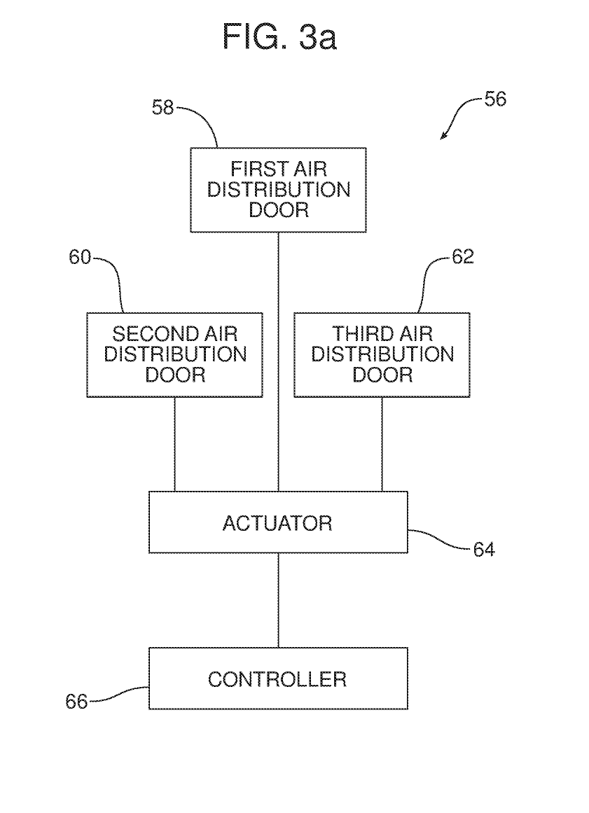

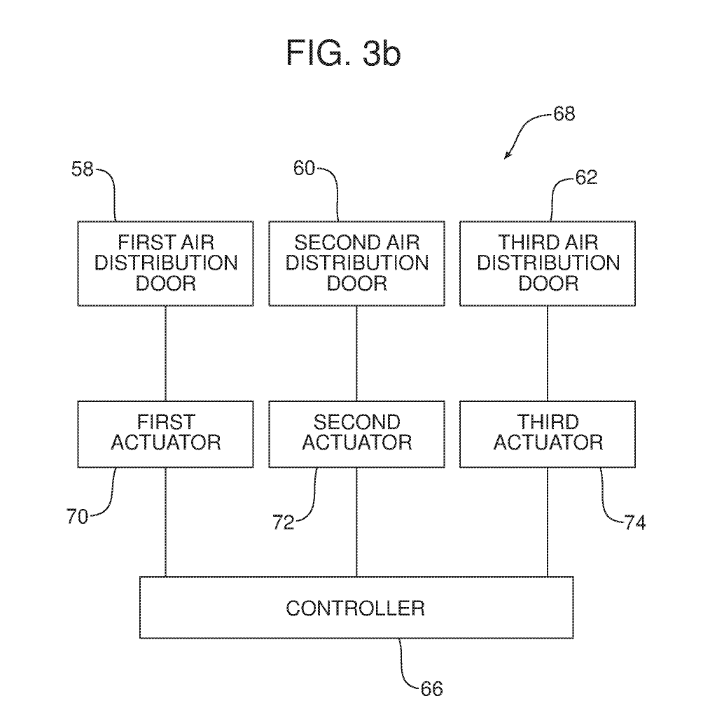

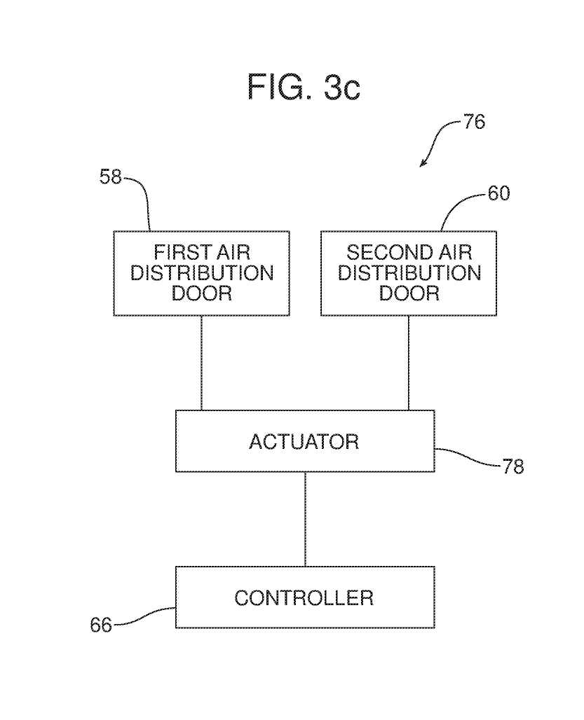

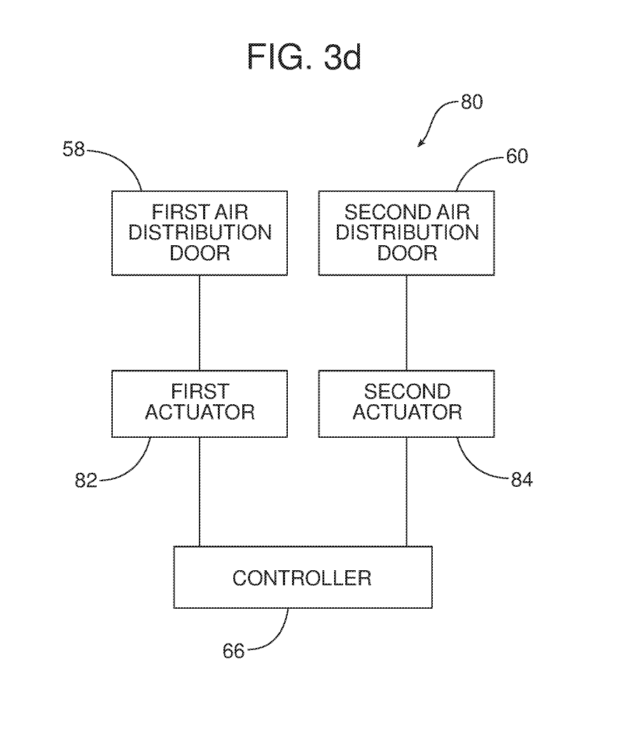

In the embodiment of the panel and defrost plenum illustrated in FIG. 3a, a single controller controlled actuator controls displacement of a first air distribution door and a second air distribution door.

In the embodiment of the panel and defrost plenum illustrated in FIG. 3b, a single controller controlled actuator controls displacement of a first air distribution door, a second air distribution door and a third air distribution door.

In the embodiment of the panel and defrost plenum illustrated in FIG. 3c, a controller controlled first actuator displaces a first air distribution door and a controller controlled second actuator displaces a second air distribution door.

In the embodiment of the panel and defrost plenum illustrated in FIG. 3d, a controller controlled first actuator displaces a first air distribution door, a controller controlled second actuator displaces a second air distribution door and a controller controlled third actuator displaces a third air distribution door.

Reference will now be made in detail to the present preferred embodiments of the panel and defrost plenum, as well as the related method of routing an airstream past a package restriction, examples of which are illustrated in the accompanying drawing figures.

### DETAILED DESCRIPTION

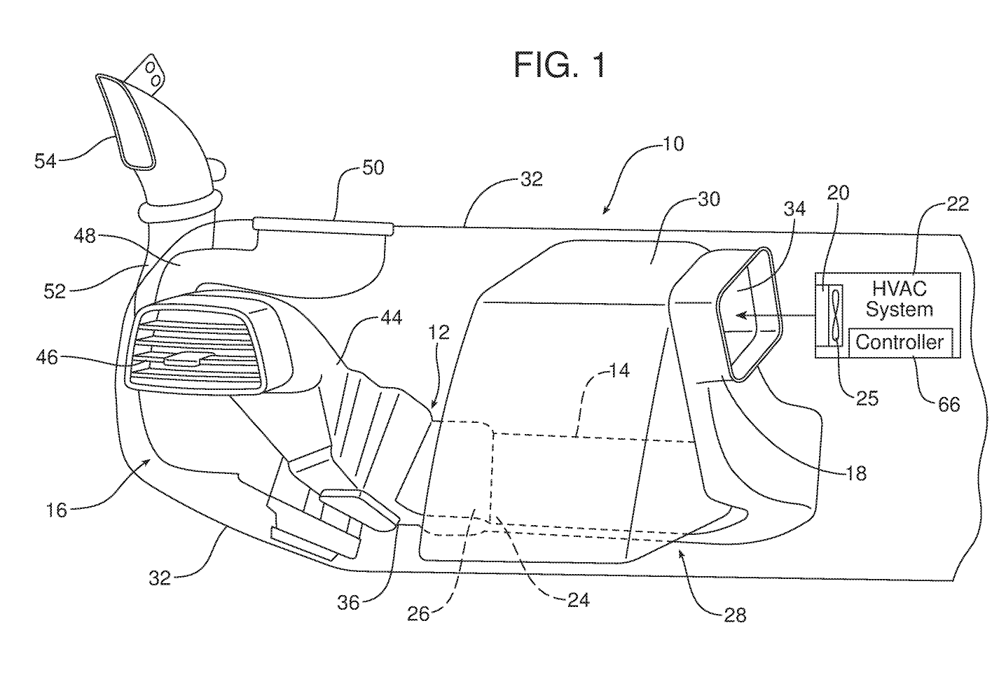

Reference is now made to FIG. 1 illustrating a first embodiment of the panel and defrost plenum 10. As illustrated, the panel and defrost plenum 10 includes a manifold section 12, an air feed section 14, upstream of the manifold section, and a branch section 16 downstream from the manifold section.

The air feed section 14 includes an inlet end 18 connected to the conditioned air supply manifold 20 of the HVAC system 22 and an outlet end 24 connected to the inlet port 26 of the manifold section 12. As shown in FIG. 1, the air feed section 14 functions to deliver an airstream past a HUD package restriction 28 (note HUD package 30 in the instrument panel 32) to the manifold section 12. In the illustrated embodiment, the air feed section 14 includes a single lumen for receiving and directing the airstream delivered by the fan 25 of the HVAC system 22.

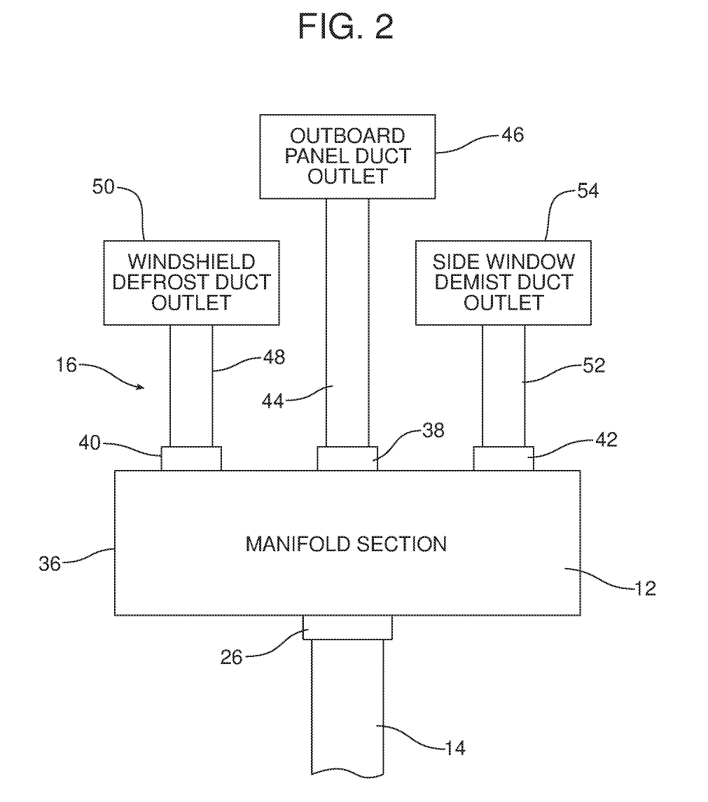

In the embodiment illustrated in FIGS. 1 and 2, the manifold section 12 includes a housing 36 defining the inlet port 26, a first air discharge port 38, a second air discharge port 40 and a third air discharge port 42. A first branch duct 44 extends from the first air discharge port 38 to an outboard panel duct outlet 46. A second branch duct 48 extends from the second air discharge port 40 to a windshield defrost duct outlet 50. A third branch duct 52 extends from the third air discharge port 42 to the side window demist duct outlet 54.

FIG. 3a illustrates a control system 56 for one possible embodiment of the panel and defrost plenum 10 wherein the manifold section 12 includes a first air distribution door 58, a second air distribution door 60, a third air distribution door 62, a single controller controlled actuator 64 and a controller 66.

In the embodiment illustrated in FIG. 3a, the first air distribution door 58 is configured to control flow of the airstream through the first air discharge port 38 to the outboard panel duct outlet 46. The second air distribution door 60 is configured to control flow of the airstream through the second air discharge port 40 to the windshield defrost duct outlet 50. The third air distribution door 62 is configured to control flow of the airstream through the third air discharge port 42 to the side window demist duct outlet 54.

The single controller controlled actuator 64 may comprise any type of actuator known in the art to be suitable for this purpose including, for example, a cam wheel connected by cables or other linkage to the first, second and third air distribution doors, 58, 60 and 62 which may be pivoted between opened and closed positions.

The controller 66 comprises a computing device such as a dedicated microprocessor or an electronic control unit (ECU) operating in accordance with instructions from appropriate control software. Thus, the controller 66 may comprise one or more processors, one or more memories and one or more network interfaces all in communication with each other over a communication bus. If desired, the controller 66 may comprise the controller for the HVAC system.

FIG. 3b illustrates a control system 68 for an alternative embodiment of the panel and defrost plenum 10. In the embodiment illustrated in FIG. 3b, the manifold section 12 includes a first air distribution door 58, configured to control flow of the airstream through the first air discharge port 38 and the first branch duct 44 to the outboard panel duct outlet 46, a second air distribution door 60 configured to control flow of the airstream through the second air discharge port 40 and the second branch duct 48 to the windshield defrost duct outlet 50 and a third air distribution door 62 configured to control flow of the airstream through the third air discharge port 42 and the third branch duct 52 into the side window demist duct outlet 54.

The control system 68 of the FIG. 3b embodiment also includes a controller 66, a controller controlled first actuator 70, a controller controlled second actuator 72 and a controller controlled third actuator 74. More specifically, the controller controlled first actuator 70 is configured to selectively displace the first air distribution door 58 between opened and closed positions. The controller controlled second actuator 72 is configured to selectively displace the second air distribution door 60 between opened and closed positions. The controller controlled third actuator 74 is configured to selectively displace the third air distribution door 62 between opened and closed positions.

FIG. 3c illustrates a control system 76 for a third possible embodiment of the panel and defrost plenum 10 wherein the manifold 12 includes only two air distribution doors: a first air distribution door 58 and a second air distribution door 60. As illustrated in FIG. 3c, the manifold section 12 also includes a single controller controlled actuator 78 for selectively displacing the first air distribution door 58 and the second air distribution door 60 between opened and closed positions. The controller 66 is configured to control the operation of the actuator 78. In this embodiment, the first air distribution door 58 is configured to control flow of the airstream through the first air discharge port 38 and first branch duct 44 to the outboard panel duct outlet 46. The second air distribution door 60 is configured to control flow of the airstream through the second air discharge port 40 to both (a) the second branch duct 48 and the windshield defrost duct outlet 50 and (b) the third branch duct 52 and the side window demist duct outlet 54.

The control system 80 for yet another possible embodiment of the panel and defrost plenum 10 that is illustrated in FIG. 3d is identical to that illustrated in FIG. 3c except that two actuators 82, 84 are provided instead of one actuator 78. More specifically, controller controlled first actuator 82 is configured to displace the first air distribution door 58 while the controller controlled second actuator 84 is configured to displace the second air distribution door 60. Thus, the controller controlled first actuator 82 may open the first air distribution door 58 to direct the airstream through the first air discharge port 38 and the first branch duct 44 to the outboard panel duct outlet 46. The controller controlled second actuator 84 is configured to control the flow of the airstream through the second air distribution door 60 and then through the second air discharge port 40 and the second branch duct 48 to the windshield defrost duct outlet 50 and the third branch duct 52 to the side window demist duct outlet 54.

Consistent with the above description, a method is provided for routing an airstream past a package restriction such as HUD package restriction 28. That method comprises the steps of delivering the airstream through a feed section 14 of the panel and defrost plenum 10 past the HUD package restriction 28 to a manifold section 12 of the panel and defrost plenum and (b) displacing a plurality of air distribution doors 58, 60 or 58, 60, 62 in the manifold section 12 to direct the airstream through a branch section 16 of the panel and defrost plenum, downstream of the manifold section, to a plurality of outlets including the outboard panel duct outlet 46, the windshield defrost duct outlet 50 and the side window demist duct outlet 54.

Toward this end, the method may include the step of providing the manifold section 12 with a plurality of air discharge ports 38, 40 or 38, 40, 42 connected to the branch section 16. Thus, in some embodiments the method may include the step of connecting the first air discharge port 38 through a first branch duct 44 to an outboard panel duct outlet 46. In some embodiments the method may include connecting the second air discharge port 40 through a second branch section duct 48 to the windshield defrost duct outlet 50. Further, some embodiments may include the step of connecting the third air discharge port 42 through a third branch section duct 52 to a side window demist duct outlet 54.

In some embodiments the method may include providing the first air distribution door 58 to control the flow of the airstream through the first air discharge port 38 and the second air distribution door 60 to control flow of the airstream through the second air discharge port 40 and the third air discharge port 42 (see FIG. 3d).

Further, in some embodiments of the method, the method includes the additional step of controlling displacement of the first air distribution door 58 and the second air distribution door 60 with a single actuator 78 (see FIG. 3c).

In some embodiments, the method includes providing the first air distribution door 58 to control flow of the airstream through the first air discharge port 38, the second air distribution door 60 to control flow of the airstream through the second air discharge port 40 and the (optional) third air distribution door 62 to control flow of the airstream through the third air discharge port 42. (See, for example, FIG. 3b.) In still other embodiments, the method may include the step of controlling displacement of the first air distribution door 58, the second air distribution door 60 and the third air distribution door 62 with a single actuator 64 as illustrated in FIG. 3a.

The panel and defrost plenum 10 includes a single duct, single lumen 34, air feed section 14 for delivering an airstream past a package restriction 28 to a manifold section 12 located on the downstream side of the package restriction: that is outboard of the package restriction and oriented in front of the instrument cluster, the steering wheel and the driver. Thus all operating systems of the manifold section 12 including the first, second and third air distribution doors 58, 60, 62 and all branch ducts 44, 48, 52 are located downstream and outboard of the package restriction to conserve space and for more effective and efficient operation.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A panel and defrost plenum, comprising:
a manifold section including a first air distribution door, a second air distribution door and at least one actuator to displace said first air distribution door and said second air distribution door between multiple operating positions;
an air feed section upstream of said manifold section, said air feed section delivering an airstream past a package restriction to said manifold section; and
a branch section downstream from said manifold section.

2. The panel and defrost plenum of claim 1, wherein said manifold section includes a first air discharge port, a second air discharge port and a third air discharge port.

3. The panel and defrost plenum of claim 2, wherein said branch section includes a first branch duct extending from said first air discharge port to an outboard panel duct outlet.

4. The panel and defrost plenum of claim 3, wherein said branch section includes a second branch duct extending from said second air discharge port to a windshield defrost duct outlet.

5. The panel and defrost plenum of claim 4, wherein said branch section includes a third branch duct extending from said third air discharge port to a side window demist duct outlet.

6. The panel and defrost plenum of claim 5, wherein said first air distribution door is configured to control flow of said airstream through said first air discharge port to said outboard panel duct outlet.

7. The panel and defrost plenum of claim 6, wherein said second air distribution door is configured to control flow of said airstream through said second air discharge port to said windshield defrost duct outlet and said third air discharge port to said side window demist duct outlet.

8. The panel and defrost plenum of claim 7, wherein said at least one actuator includes a first actuator configured to displace said first air distribution door and a second actuator configured to displace said second air distribution door.

9. The panel and defrost plenum of claim 6, wherein said manifold section includes a third air distribution door.

10. The panel and defrost plenum of claim 9, wherein said second air distribution door is configured to control flow of said airstream through said second air discharge port to said windshield defrost duct outlet.

11. The panel and defrost plenum of claim 10, wherein said third air distribution door is configured to control flow of said airstream through said third air discharge port to said side window demist duct outlet.

12. A method of routing an airstream past a package restriction, comprising:
delivering said airstream in a feed section of a plenum past said package restriction to a manifold section of said plenum; and
displacing a plurality of air distribution doors in said manifold section to direct said airstream through a branch section of said plenum, downstream of said manifold section, to a plurality of outlets.

13. The method of claim 12 including providing said manifold section with a plurality of air discharge ports connected to said branch section.

14. The method of claim 13 including connecting a first air discharge port with an outboard panel duct outlet.

15. The method of claim 14, including connecting a second air discharge port with a windshield defrost duct outlet.

16. The method of claim 15, including connecting a third air discharge port with a side window demist duct outlet.

17. The method of claim 16, including providing a first air distribution door to control flow of said airstream through said first air discharge port and a second air distribution door to control flow of said airstream through said second air discharge port and said third air discharge port.

18. The method of claim 17, including controlling displacement of said first air distribution door and said second air distribution door with a single actuator.

19. The method of claim 16, including providing a first air distribution door to control flow of said airstream through said first air discharge port, a second air distribution door to control flow of said airstream through said second air discharge port and a third air distribution door to control flow of said airstream through said third air discharge port.

20. The method of claim 19, including controlling displacement of said first air distribution door, said second air distribution door and said third air distribution door with a single actuator.
